(19) United States
(12) Patent Application Publication
(10) Pub. No.: US 2012/0113650 A1
(43) Pub. Date: May 10, 2012

(54) INSULATING WHITE GLASS PASTE FOR FORMING INSULATING REFLECTIVE LAYER

(75) Inventor: Sanjuro Inoue, Kanagawa (JP)

(73) Assignee: E.I. DU PONT DE NEMOURS AND COMPANY, Wilmington, DE (US)

(21) Appl. No.: 12/943,304

(22) Filed: Nov. 10, 2010

(51) Int. Cl. F21V 7/22; C03C 8/20; B05D 5/06; F21V 7/00

(52) U.S. Cl. 362/296.02; 362/341; 501/18; 427/126.2

(57) ABSTRACT

An insulating white glass paste suitable for forming an insulating reflective layer to be provided on a lighting device substrate, comprising an organic medium and inorganic components comprising glass frit and zirconia powder as a light-reflecting filler.

### BACKGROUND OF THE INVENTION

1. Field of the Invention

The invention relates primarily to a lighting device substrate. More specifically, it relates to an insulating white glass paste for forming an insulating reflective layer to be provided on a lighting device substrate.

2. Description of Related Art

In a lighting device, part of the light emitted by the light source is absorbed by the substrate or passes through the substrate. This has led to the problem of low luminous efficiency, in which luminous efficiency cannot be achieved at 100% because the observed luminescence is less than the amount of light actually emitted by the light source. In the case of circuit substrates for lighting devices, the substrate itself is, in an embodiment, highly reflective in order to improve the luminous efficiency of the lighting device at least somewhat.

Conventionally, heat-dissipating metal base materials and heat-dissipating and insulating aluminum base materials have been used for the circuit substrates of lighting devices. To improve the reflectance of the substrates themselves, a technology has been proposed for a lighting device substrate having an insulating reflective layer of thermosetting resin or glass containing a white pigment.

As lighting devices have gotten smaller and more sophisticated in recent years, the circuit substrates of these lighting systems are being required to be even more heat resistant, and insulating reflective layers made of thermosetting resin such as those of the aforementioned prior art may be liable resin deterioration due to heat. On the other hand, insulating reflective layers made of glass are highly heat resistant, and the documents such as the following relate to the use of such glass layers as insulating reflective layers.

WO 2010042573 discloses a circuit substrate for a lighting device having an insulating reflective layer formed by baking a glass paste containing an inorganic powder such as titanium oxide (TiO₂), aluminum oxide (Al₂O₃) or silicon dioxide (SiO₂) as a white pigment.

### SUMMARY OF THE INVENTION

It is an object to provide an insulating white glass paste with the aim of obtaining a circuit substrate with high reflectance for use in a lighting device. This object is achieved by providing an insulating white glass paste suitable for forming an insulating reflective layer to be provided on a lighting device substrate, comprising an organic medium and inorganic components comprising glass frit and zirconia powder as a light-reflecting filler.

It is another object to provide a lighting device substrate comprising an insulating reflective layer with high reflectance. This object is achieved by providing a lighting device substrate comprising an inorganic substrate and an insulating reflective layer comprising glass and zirconia powder on one surface side of the inorganic substrate.

It is another object to provide a method of manufacturing a lighting device substrate comprising an insulating reflective layer with high reflectance. This object is achieved by providing a method of manufacturing a lighting device substrate, comprising steps of; applying a glass paste comprising zirconia powder to one surface side of an inorganic substrate, and firing the inorganic substrate and glass paste to thereby form an insulating reflective layer.

The circuit substrate of a lighting device with high reflectance can be obtained.

### BRIEF DESCRIPTION OF THE DRAWINGS

FIG. 1 is an exemplary cross-sectional view of a lighting device substrate.

FIG. 2 is an exemplary cross-sectional view of another lighting device substrate.

FIG. 3 is an exemplary cross-sectional view of another lighting device substrate.

### DETAILED DESCRIPTION OF THE INVENTION

### 1. Insulating White Glass Paste

The insulating white glass paste includes (i) an inorganic component containing a glass frit and a zirconia powder as an optical reflecting filler, and (ii) an organic medium.

The content of the inorganic component is 30 to 85 wt % in an embodiment, 40 to 70 wt % in another embodiment based on the total weight of the insulating white glass paste.

### (A) Glass Frit

The insulating white glass paste contains an inorganic medium in the form of glass frit.

The content of the glass frit in the insulation white glass paste, but is not limited to, 20 vol % to 95 vol % in an embodiment, and 25 vol % to 80 vol % in another embodiment based on the total volume of the inorganic component.

The volume percent of the glass frit based on the total volume of the inorganic components is determined by the following method. The weight (g) of the glass frit is measured, and divided by the true specific gravity (g/cm³) of the glass frit to determine the volume of glass frit. The volumes of the inorganic components other than glass frit are determined in the same way from their weights and specific gravities, and added to the volume of the glass frit to determine the total volume of the inorganic components. The volume of the glass frit is then divided by the total volume of the inorganic components and multiplied by 100 to obtain the volume percent of glass frit.

For example, when the only inorganic components in the glass paste are glass frit and ZrO₂ powder, the volume percent of glass frit is determined by the following formula:

Vol % of glass frit=[(weight(g) of glass frit/true specific gravity(g/cm³) of glass frit)/{(weight(g) of glass frit/true specific gravity(g/cm³) of glass frit)+(weight(g) of ZrO₂/true specific gravity(g/cm³) of ZrO₂)}]×100

True specific gravity is a parameter representing the density of powder, and the gaps between particles are excluded from the volume of the powder. The volume occupied by the powder itself regardless of shape and size is the volume used for calculating density. True specific gravity can be measured by the following method. True specific gravity is measured by the pycnometer method (JIS R-1620-1995).

Glass frit composition is not limited. Glass frit can include, for instance, various glass types such as Silica-based glass, Bismuth-based glass or the like. An amorphous glass is used in an embodiment in terms of preventing cracks in the insulating reflective layer. Cracking is less likely to occur when using an amorphous glass than when using a crystalline glass.

The glass frit contains at least Bismuth oxide (Bi₂O₃), Boron oxide (B₂O₃) and Silica oxide (SiO₂) in an embodiment. In an embodiment, it further contains Zinc oxide (ZnO).

For environmental purposes, bismuth oxide (Bi₂O₃) is effective as a substitute for lead in lead-free glass. Bismuth (Bi) and lead (Pb) are adjacent elements on the periodic table, and are known to have many similar properties including high polarizability and the like, but bismuth is known to be much less toxic than lead. Bismuth (Bi₂O₃) does not form glass by itself, but is known to form glass when other oxides are added thereto. The content of Bi₂O₃ is 40-90 wt % in an embodiment based on the total weight of the glass frit. More 50-80 wt % in another embodiment and 60-75 wt % in further another embodiment.

B₂O₃ ordinarily tends to suppress the glass crystallization. The presence of B₂O₃ also allows reducing the glass transition temperature and the softening temperature of the glass frit, which in turn makes it possible to lower the firing temperature. The content of B₂O₃ is 2-30 wt % in an embodiment based on the total weight of the glass frit, 3-20 wt % in another embodiment, and 5-10 wt % in further another embodiment.

SiO₂ has the function of forming a network in the glass frit. The content of SiO₂ is 1-40 wt % in an embodiment based on the total weight of the glass frit, more 3-20 wt % in another embodiment, and 5-10 wt % in further another embodiment. The content of silica can be adjusted from the view points of the softening point of glass and the glass crystallization. Less content of silica tends to lower the softening point of glass, while more content of silica tends to suppress the glass crystallization.

ZnO lowers the softening point, increases the flowability of glass, and enhances the electric characteristics of the insulating reflective layer. The content of ZnO is 1-20 wt % in an embodiment based on the total weight of the glass frit, 5-18 wt % in another embodiment, and 7-15 wt % in further another embodiment. Less content of ZnO tends to increase the TCE of glass. When using a metal substrate in particular, the content of zinc oxide can also be adjusted so as to adjust the temperature coefficient of expansion (TCE) of the insulating reflective layer derived from the glass paste. Less content of ZnO tends to increase the TCE of glass. Making the TCE of the insulating reflective layer approximate the TCE of the metal substrate is an effective way of controlling warpage of the fired substrate.

The glass frit may further contain Al₂O₃, BaO.

Barium oxide (BaO) is effective in increasing the temperature coefficient of expansion (TCE) of the insulating reflective layer derived from the glass paste. The TCE of glass is normally lower than that of a metal substrate such as stainless steel. Due to this TCE difference, a substrate warpage tends to be caused when an insulating glass paste is coated onto a metal substrate and fired. Hence, barium oxide can suppress such substrate warpage. The content of BaO is less than 10 wt % in an embodiment, less than 8 wt % in another embodiment, less than 5 wt % in further another embodiment based on the total weight of the glass frit.

Moreover, adding alumina (Al₂O₃) allows enhancing chemical durability. The content of alumina can be also adjusted from the view point of suppressing the glass crystallization. Less content of alumina tends to suppress glass crystallization, since alumina functions as a crystallization promoter. The content of Al₂O₃ is less than 10 wt % in an embodiment, less than 8 wt % in another embodiment, less than 5 wt % in further another embodiment based on the total weight of the glass frit.

The above glass frit may also contain any components other than the above-listed ones.

The glass fits described herein can be manufactured by conventional glass making techniques. The following procedure is one example. Ingredients are weighed then mixed in the desired proportions and heated in a furnace to form a melt in platinum alloy crucibles. As well known in the art, heating is conducted to a peak temperature (800-1400 deg C.) and for a time such that the melt becomes entirely liquid and homogeneous. The molten glass is then quenched between counter rotating stainless steel rollers to form a 10-15 mil thick platelet of glass. The resulting glass platelet is then milled to form a powder with its 50% volume distribution set between to a desired target (e.g. 0.8-1.5 μm). One skilled in the art of producing glass frit may employ alternative synthesis techniques such as but not limited to water quenching, sol-gel, spray pyrolysis, or others appropriate for making powder forms of glass. US patent application numbers US 2006/231803 and US 2006/231800, which disclose a method of manufacturing a glass useful in the manufacture of the glass frits described herein, are hereby incorporated by reference herein in their entireties.

One of skill in the art would recognize that the choice of raw materials could unintentionally include impurities that may be incorporated into the glass during processing. For example, the impurities may be present in the range of hundreds to thousands ppm. However, the presence of the impurities would not alter the properties of the glass, the glass paste.

### (B) Light-Reflecting Filler (Zirconia Powder)

This zirconia power is a component that is compounded as a light-reflecting filler, thereby making the glass paste white. The term “white” includes not only white color but also other slightly mixed colors such as cream color.

The applicant has found out that the zirconia powder can reflect visible light (380 to 830 nm), especially blue light (380 to 500 nm), more effectively than conventional white pigment such as alumina and titanium oxide. Considering the fact that a blue light tends to be less reflected, the insulating white glass paste containing the zirconia powder as a white pigment can be very useful for producing an excellent insulating reflective layer for an illuminating device, especially for a blue LED.

From the standpoint of reflectance, the content of the zirconia powder is 5 vol % or more in an embodiment, 20 vol % or more in another embodiment, and 50 vol % or more in further another embodiment based on the total volume of the inorganic components of the insulating white glass paste. From the standpoint of the strength of the insulating reflective layer, on the other hand, the upper limit of the zirconia power is 80 vol % in an embodiment, 75 vol % in another embodiment, and 70 vol % in further another embodiment based on the total volume of the inorganic components of the insulating white glass paste.

The volume percent of ZrO₂ based on the total volume of the inorganic components is determined as follows. The weight (g) of the ZrO₂ powder is measured and divided by the true specific density (g/cm³) of the ZrO₂ powder to determine the volume of the powder. The volumes of the inorganic components other than ZrO₂ powder are determined in the same way from their weights and true specific densities. The volume of the ZrO₂ powder is then divided by the total volume of the inorganic components, and multiplied by 100 to determine the volume percent of the ZrO₂ powder.

When the only inorganic components in the glass paste are glass frit and ZrO₂ powder, the following formula is used.

Vol % of ZrO₂ powder=[(weight(g) of ZrO₂/true specific gravity(g/cm³) of ZrO₂)/{(weight(g) of glass frit/true specific gravity(g/cm³) of glass frit)+(weight(g) of ZrO₂/true specific gravity(g/cm³) of ZrO₂)}]×100

The specific surface area (SA) of the zirconia powder is at least 5 m²/g in an embodiment, at least 10 m²/g in another embodiment, and at least 20 m²/g in further another embodiment from the standpoint of obtaining adequate light-reflecting area in the light-reflecting filler. The upper limit of SA is 45 m²/g in an embodiment, 40 m²/g in another embodiment, and 38 m²/g in further another embodiment from the standpoint of adequately dispersing the ZrO₂ powder in the organic binder and increasing the effective reflective area. The SA of the ZrO₂ powder is determined by the BET method.

The ZrO₂ powder can be a mixture of ZrO₂ powders with different SA values. As shown in the examples below, this is because greater reflectance is obtained with an insulating reflective layer containing two types of ZrO₂ powder with different SA values than with an insulating reflective layer containing ZrO₂ powder with only one SA value (cf. Examples 3 and 7).

The purity of the zirconia powder is 99% or more in an embodiment. ZrO₂ powder normally contains a small amount of HfO₂. This is because hafnium is a IVa element like zirconium and has a similar chemical properties, making it difficult to separate hafnium out during the ZrO₂ powder manufacturing process. Consequently, in industrial raw materials purity is normally controlled in terms of “zirconia+hafnium”, with hafnium included because it is difficult to separate out.

The zirconia powder can be commercially available. Commercially available zirconia powder, such as SPR-2 produced by Daiichi Kigenso Kagaku Kogyo Co., Ltd., can be used.

### (Substitute Light-Reflecting Filler)

Substitute light-reflecting filler can be substituted for part of the ZrO₂ powder. The substitutive reflecting filler is, not particularly limited, may be silica (SiO₂), alumina (Al₂O₃), titania (TiO₂), zinc oxide (ZnO), aluminum nitride (AlN), boron nitride (BN) or a mixture thereof. Because these substitute light-reflecting fillers have different TCE values from ZrO₂, they can be used together with ZrO₂ powder for the purpose of matching the TCE values of the glass paste and an inorganic substrate in particular. The content of the substitutive reflecting filler in the insulating paste, but not limited to, does not exceed 30 vol % in an embodiment, and does not exceed 10 vol % in another embodiment based on the total volume of

### (C) Organic Medium

An organic medium is used to allow constituents such as glass frit and reflecting filler to be dispersed in the paste. The organic medium may be an organic binder or a mixture of an organic binder and an organic solvent. The organic medium is burned off in sintering process at elevated temperature.

Examples of the organic binder of the organic mediums include poly(vinyl butyral), poly(vinyl acetate), poly(vinyl alcohol), cellulosic polymers such as methyl cellulose, ethyl cellulose, hydroxyethyl cellulose, methylhydroxyethyl cellulose, atactic polypropylene, polyethylene, silicon polymers such as poly(methyl siloxane), poly (methylphenyl siloxane), polystyrene, butadiene/styrene copolymer, polystyrene, poly (vinyl pyrrolidone), polyamides, high molecular weight polyethers, copolymers of ethylene oxide and propylene oxide, polyacrylamides, and various acrylic polymers such as sodium polyacrylate, poly(lower alkyl acrylates), poly(lower alkyl methacrylates) and various copolymers and multipolymers of lower alkyl acrylates and methacrylates such as copolymers of ethyl methacrylate and methyl acrylate and terpolymers of ethyl acrylate, methyl methacrylate and methacrylic acid.

The organic medium may optionally contain an organic solvent. Therefore, when calculating the content of the organic medium, the content of the organic solvent, which is an optional component, also has to be taken into account in the calculation. The primary purpose for using an organic solvent is to allow the dispersion of solids contained in the composition to be readily applied to the substrate. As such, the organic solvent is, in an embodiment, one that allows the solids to be dispersed while maintaining suitable stability. Secondly, the rheological properties of the organic solvent may endow the dispersion with favorable application properties.

The organic solvent may be a single component or a mixture of organic solvents. The organic solvent may be selected so that it can dissolve the polymer and other organic components completely. The organic solvent may be selected so that it is inert to the other ingredients in the composition. The organic solvent has sufficiently high volatility in an embodiment, and may be able to be evaporated off from the dispersion even when applied at a relatively low temperature in the atmosphere. The solvent is, in an embodiment, so volatile that the paste on the screen will rapidly dry at ordinary temperature during the printing process.

The boiling point of the organic solvent at ordinary pressure is no more than 300 deg C. in an embodiment, and no more than 250 deg C. in another embodiment. The lower limit of the boiling point is 100 deg C. in an embodiment. The lower limit can be determined out of considerations of workability.

Specific examples of organic solvents include aliphatic alcohols and esters of those alcohols such as acetate esters or propionate esters; terpenes such as turpentine, terpineol, or mixtures thereof; ethylene glycol or esters of ethylene glycol such as ethylene glycol monobutyl ether or butyl cellosolve acetate; butyl carbitol or esters of carbitol such as butyl carbitol acetate and carbitol acetate; and texanol (2,2,4-trimethyl-1,3-pentanediol monoisobutyrate). When ethyl cellulose is used as the organic binder, the solvent is terpineol in an embodiment, because this solvent dissolves ethyl cellulose well.

The content of the organic medium including an optional organic solvent in the insulating paste, but is not limited to, 15 to 70 wt % in an embodiment, and 30 to 60 wt % in an embodiment based on the total weight of the insulating white glass paste. The content of the organic medium is actually adjustable to obtain suitable viscosity to applying onto a substrate. A viscosity for these compositions is, in an embodiment, approximately 100 to 300 Pa s measured on a Brookfield HBT viscometer using a #14 spindle at 10 rpm at normal temperature.

### (Additives)

Thickener, stabilizer or surfactant as additives may be added to the insulating paste. Other common additives such as a dispersant, viscosity-adjusting agent, and so on can also be added. The amount of the additive depends on the desired characteristics of the resulting insulating white glass paste and can be chosen by people in the industry. The additives can also be added in multiple types.

### (D) Preparation of the Paste

The insulation paste is obtained by mixing the constituents of the paste. The pastes are conveniently prepared on a three-roll mill. A viscosity for these compositions is, in an embodiment, approximately 100 to 300 Pascal second measured on a Brookfield HBT viscometer using a #14 spindle at 10 rpm at room temperature.

### 2. Lighting Device Substrate

### (A) Substrate Material

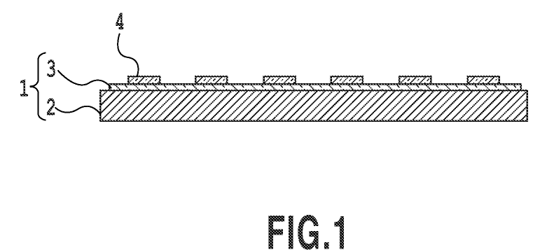

The lighting device substrate and manufacturing method are explained with reference to FIG. 1 to FIG. 3. Lighting device substrate 1 can be obtained by forming insulating reflective layer 3 on inorganic substrate 2. Inorganic substrate 2 is a ceramic in an embodiment and metal substrate in another embodiment.

A ceramic substrate may be a solid obtained by molding, drying and firing a powder of a non-metal inorganic substance, and has a plate form for mounting electronic components including a light source. Examples include oxide ceramics, non-oxide ceramics, nitride ceramics, carbide ceramics and the like. More specifically, the substrate consists principally of alumina, aluminum nitride, zirconia, silicon carbide, silicon nitride or mullite (3Al₂O₃.SiO₂). Because a ceramic substrate has a lower TCE than a metal substrate, the substrate is less likely to warp when a glass paste is applied and fired at a high temperature. Alumina substrates or aluminum nitride substrates are particularly desirable ceramic substrates because of their superior heat-dissipating properties.

When it comes to heat-dissipating properties, aluminum nitride is superior. Alumina substrates are among the most commonly used ceramic substrates because they are relatively cheap and easy to obtain commercially.

A metal substrate is a metal body consisting mainly of a precious or base metal, and has a plate form for mounting electronic components including a light source. Examples of metal substrates include iron substrates, aluminum substrates, copper substrates, copper alloy substrates, nickel substrates, nickel alloy substrates, silicon-steel substrates, and stainless steel substrates. Examples include aluminum substrates, copper substrates, silicon-steel substrates and stainless steel substrates. Stainless steel substrates are used for their superior heat-dissipating properties in an embodiment. Because metal substrates have superior heat-dissipating properties, they are useful when the light source generates a large amount of heat in the lighting device. However, since some ceramic substrates such as aluminum nitride substrates for example also have superior heat-dissipating properties, the choice between a ceramic substrate and metal substrate can be made appropriately considering the conditions of use as a whole.

Inorganic substrates 2 having high thermal conductivity may be selected for packaging with high heat-generating light-emitting devices. Although not particularly limited, thermal conductivity is no smaller than 1 W/mK in an embodiment, no smaller than 10 W/mK in another embodiment. Within the above ranges, heat can be efficiently dissipated from the mounted light-emitting device.

The thickness of the insulating reflective layer 3 is from 10 to 30 micrometers (μm) in an embodiment, 15 to 25 μm in another embodiment. The lower limit of the thickness of insulating reflective layer 3 can be determined so as to obtain satisfactory reflectance. The upper limit of the thickness of insulating reflective layer 3 can be determined out of considerations of heat dissipation.

### (B) Disposition of Light-Emitting Device

A light-emitting device is a device comprising a light-emitting body used as a light source. The light-emitting body is not particularly limited as long as it emits light, and examples include incandescent light bulbs, fluorescent lamps, halogen light bulbs, high-intensity discharge (HID) lamps, sodium lamps, light-emitting diodes and the like. A blue light-emitting diode is used in an embodiment. This is because the zirconia powder in insulating reflective glass layer 2 has excellent reflectance of light at 460 nm as shown in the Examples below. Blue light is visible light having a wavelength between 380 nm and 500 nm.

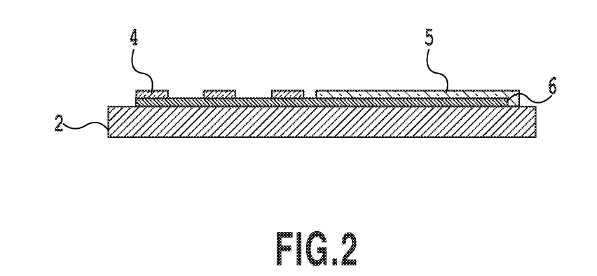

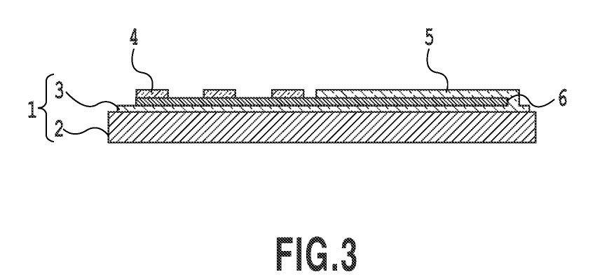

Light-emitting device 4 can be disposed on and/or next to insulating reflective layer 3. In a structure having light-emitting device 4 disposed on insulating reflective layer 3, the light-emitting device can be mounted directly on insulating reflective layer 3 as shown in FIG. 1 for example. In a structure having light-emitting device 4 disposed next to insulating reflective layer, on the other hand, if electronic circuit 6 is formed between inorganic substrate 2 and light-emitting device 4 for example as shown in FIG. 2, insulating reflective layer 5 is formed so as to cover that part of electronic circuit 6 where the light-emitting device is not mounted. In a structure having light-emitting device 4 disposed on and next to insulating reflecting layer, insulating reflective layer 3 is first formed on inorganic substrate 2 for example as shown in FIG. 3, and when electronic circuit 6 is formed between this insulating reflective layer 3 and light-emitting device 4, a further insulating reflective layer 5 is formed so as to cover that part of the electronic circuit 6 not covered by the light-emitting device. With this arrangement, it is possible to effectively reflect light from light-emitting device 4 while protecting electronic circuit 6.

### (C) Method of Preparing Lighting Device Substrate

The lighting device substrate 1 may be but is not limited to being manufactured by the following process.

The aforementioned insulating white glass paste containing zirconia (ZrO₂) powder is applied onto an inorganic substrate 2. In case that screen printing is used for applying the paste, an insulating white glass paste may have appropriate viscosity so as to readily pass through a screen mesh. In addition, an insulating white glass paste may be thixotropic in order that they set up rapidly after being screened, thereby giving good resolution.

The insulating white glass paste which is applied on the inorganic substrate 2 is dried at 100 to 400 deg C. for 10 to 60 minutes in an embodiment.

The dried insulating white glass paste is fired together with inorganic substrate 2, becoming insulating reflecting layer 3. During the sintering process, the glass powder in the paste melts and becomes firmly attached to inorganic substrate 2. The firing temperature of the glass paste is at least 500 deg C. or more in an embodiment, and at least 600 deg C. in another embodiment. The lower limit of the firing temperature range can be determined so as to facilitate melting of the glass and formation of the insulating reflective layer. The firing temperature is no more than 800 deg C. in an embodiment, and no more than 700 deg C. in another embodiment. The upper limit of the firing temperature range can be determined so as to prevent crack formation in the insulating reflective layer attributable to the volume of the zirconia itself due to changes in the crystal system of the zirconia.

After formation of insulating reflective layer 3, light-emitting device 4 is attached with an adhesive or the like on and/or next to insulating reflective layer 3. Either electronic circuit 6 comprising an electrode or an electrical circuit connecting the light-emitting device to a power source can be formed between light-emitting device 4 and insulating reflective layer 3 (see FIG. 3), or between light-emitting device 4 and inorganic substrate 2 (see FIG. 2), or around the light-emitting device. Electronic circuit 6 can be formed by curing or firing a conductive paste. In addition to the light-emitting device, this circuit can be provided with other electronic devices such as chip resistors. At least part of insulating reflective layer 5 can be formed above at least part of this circuit, and in this case, insulating reflective layer 5 functions not only as insulating reflective layer 5 of the lighting device, but also as a protective layer for electronic circuit 6 (see FIGS. 2 and 3).

The compositions of insulating reflective layers 3 and 5 in a lighting device substrate 1 produced in this way derive from the insulating white glass paste after the firing step in which a glass layer is formed by softening or melting of the glass frit while the organic medium in the paste is burned off, leaving the light-reflecting filler dispersed in the glass layer. Hence, the weights of the glass and ZrO₂ powder are roughly the same as before firing.

The formed insulating reflective layers 3 and 5 comprise glass layers formed when the glass frit is softened or melted by firing, and zirconia powder dispersed in the glass layers. At firing temperatures below 900 deg C., the zirconia powder is only dispersed in a powder state in the glass layer, and does not form part of the glass layer. The zirconia powder can effectively fulfill the function of a light-reflecting filler if it is in such a dispersed state.

The zirconia powder in the insulating reflective layer 3 and 5 is derived from the zirconia powder in the insulating white glass paste. Hence, the content of the zirconia powder in the insulating reflective layer 3 and 5 is approximately the same as that in the inorganic component of the insulating white glass paste. Specifically, the content of the zirconia powder is from 10 vol % to 80 vol % in an embodiment based on the volume of the insulating reflective layer 3 and 5. The specific surface area of the zirconia powder in insulating reflective layers 3 and 5 is 5 m²/g to 45 m²/g in an embodiment, 10 m²/g to 40 m²/g in another embodiment, and 20 m²/g to 38 m²/g in further another embodiment for purposes of light reflection.

### EXAMPLES

The embodiment of the invention is illustrated by, but is not limited to, the following examples.

### 1. Preparation of the Insulating White Glass Paste

### Example 1

5 weight parts of Ethyl cellulose was dissolved in 39.5 weight parts of terpineol to form an organic solution. 1.6 weight parts of dispersant was added to the organic solution under stirring. 85 weight parts of glass frit with a true specific gravity of 6 g/cm³ and 54 weight parts of ZrO₂ powder as a light-reflecting filler with a SA of 23 m²/g and a true specific gravity of 6 g/cm³ (UEP, Daiichi Kigenso Kagaku Kogyo Co., Ltd.) were dispersed in the organic solution, and then mixed well with a three-roll mill to yield insulating white glass paste. The principal components of the glass frit were 67.5 wt % Bi₂O₃, 10.5 wt % ZnO, 7.5 wt % SiO₂ and 7.5 wt % B₂O₃. This glass contained no ZrO₂ powder. The volume % of ZrO₂ based on the total volume of the inorganic components (glass frit and ZrO₂) was 39 vol %. The content of the glass frit and the light-reflecting filler in volume % are shown in Table 1. The volume percentages were determined according to the following formula:

Vol % of ZrO₂ powder(39 vol %)=[(weight(54 g) of ZrO₂/true specific gravity(6 g/cm³) of ZrO₂ powder)/{(weight(54 g) of ZrO₂/true specific gravity(6 g/cm³) of ZrO₂ powder)+(weight(85 g) of glass frit/true specific gravity(6 g/cm³) of glass frit}]×100

### Examples 2-5

As in Example 1, except that the volume (vol %) of ZrO₂ powder was adjusted as shown in Table 1. The amount (vol %) of glass frit is 100 vol % minus the amount (vol %) of ZrO₂ powder in Table 1.

### Example 6

As in Example 1, but using ZrO₂ powder with an SA of 34 m²/g and a true specific gravity of 6 g/cm³ (SRP-2, Daiichi Kigenso Kagaku Kogyo Co., Ltd.). The amounts of glass frit and ZrO₂ powder were adjusted as shown in Table 1.

### Example 7

As in Example 1, except that a mixture of ZrO₂ powder with an SA of 23 m²/g and a true specific gravity of 6 g/cm³ (UEP, Daiichi Kigenso Kagaku Kogyo Co., Ltd.) and ZrO₂ powder with an SA of 34 m²/g and a true specific gravity of 6 g/cm³ (SPR-2, Daiichi Kigenso Kagaku Kogyo Co., Ltd.) was used. The amounts of the glass frit, ZrO₂ powder with an SA of 23 m²/g and ZrO₂ powder with an SA of 34 m²/g were adjusted as shown in Table 1.

### Example 8

As in Example 1, except that ZrO₂ powder with an SA of 6.4 m²/g and a true specific gravity of 6 g/cm³ (SPZ, Daiichi Kigenso Kagaku Kogyo Co., Ltd.) was used. The amounts of the glass frit and ZrO₂ powder were adjusted as shown in Table 1.

### Comparative Example 1

As in Example 1, except that Al₂O₃ powder with an SA of 6.0 m²/g and a true specific gravity of 4 g/cm³ (A-161 SG, Showa Denko Aluminum Trading K.K.) was used as the light-reflecting filler. The amounts of the glass frit and Al₂O₃ powder were adjusted as shown in Table 1.

### Comparative Example 2

As in Comparative Example 1, except that the amounts of the glass frit and Al₂O₃ powder were adjusted as shown in Table 1.

### Comparative Example 3

As in Comparative Example 1, except that TiO₂ powder with an SA of 11 m²/g and a true specific gravity of 4.25 g/cm³ (A100, Ishihara Sangyo Kaisha, Ltd.) was used as the light-reflecting filler. The amounts of the glass frit and TiO₂ filler adjusted as shown in Table 1.

### Comparative Examples 4-6

As in Comparative Example 3, except that the glass frit and TiO₂ powder were adjusted as shown in Table 1.

The SA values and true specific gravities of the ZrO₂, Al₂O₃ and TiO₂ are the nominal values.

### 2. Formation of Lighting Device Substrate

The insulating white glass pastes were printed on an alumina (Al₂O₃) substrate with thickness of 21 micrometers in average. The thickness of the alumina substrates were 0.64 mm. Both of width and length of the substrate was 25.4 mm.

The substrates with the printed glass pastes were dried at 150 deg C. for 10 minutes, and then fired in a heating belt furnace. The maximum set temperature during firing was 650 deg C. Firing In-Out time which was from an entrance till an exit of the furnace was 1.5 hours.

### 3. Measurement Method of Relative Reflectance Value

Relative Reflectance value of the insulating reflective layers at 460 nm, 546 nm and 700 nm wave lengths respectively were measured with a spectrophotometer (UV-2550PC/MPC-2200. Shimadzu Co. Ltd.). A pure barium sulfate (BaSO₄) powder was used as a reference for 100% reflectance value. The results are shown in Table 1.

### 4. Result

As Table 1 shows, Example 1-8 using ZrO₂ powder obtained relative reflectance value of with 92 or higher at 460 nm wave length while Comparative example obtained 91 or lower. The insulating reflective layer prepared with the glass paste containing ZrO₂ powder showed the highest reflectance value at 460 nm among those at various wave lengths (460, 546 and 700 nm). Even at 546 nm, moreover, the relative reflectance values obtained with the ZrO₂ powder were 90% or more except in Example 5, and were higher than the values obtained with insulating reflective layers containing Al₂O₃ powder and TiO₂ powder. Even at 700 nm, moreover, relative reflectance values of 90% or more were obtained in Examples 2, 3 and 6 to 8 in which the content of ZrO₂ powder was 49 or 59 vol %, and these values were higher than those obtained with insulating reflective layers containing Al₂O₃ powder and TiO₂ powder.

The insulating reflective layer containing ZrO₂ showed higher reflectance value, when compared Example 8 using ZrO₂ powder having 6.4 m²/g of the surface area (SA), with Comparative Example 1 using Al₂O₃ having 6 m²/g SA, and Comparative example 5 using TiO₂ having 11 m²/g SA. TiO₂ filler may cause yellowing of the glass layer paste during firing, which tends to detract from reflectance. It may also be that the ZrO₂ filler provides greater reflectance because it is superior to Al₂O₃ in terms of refractive index.

According to Examples 3, 6 and 7, the glass paste containing ZrO₂ powder having 34 m²/g SA showed higher reflectance value than containing just ZrO₂ powder having 23 m²/g SA. Moreover, Examples 6 to 8 using 59 vol. % of ZrO₂ powder showed especially high reflectance values at any wave length (460 to 700 nm).

As a result, it has been showed ZrO₂ powder was more effective than the others on Relative reflectance.

TABLE 1

| | Light-reflecting filler (vol %) | | | | | Reflectance (%) | | |
|---|---|---|---|---|---|---|---|---|
| | TiO₂ | Al₂O₃ | ZrO₂ | | | 460 | 546 | 700 |
| SA(m²/g) | 11 | 6 | 6.4 | 23 | 34 | nm | nm | nm |
| Example 1 | 0 | 0 | 0 | 39 | 0 | 92 | 90 | 88 |
| Example 2 | 0 | 0 | 0 | 49 | 0 | 94 | 92 | 90 |
| Example 3 | 0 | 0 | 0 | 59 | 0 | 95 | 94 | 91 |
| Example 4 | 0 | 0 | 0 | 64 | 0 | 94 | 90 | 87 |
| Example 5 | 0 | 0 | 0 | 69 | 0 | 92 | 88 | 85 |
| Example 6 | 0 | 0 | 0 | 0 | 59 | 99 | 97 | 95 |
| Example 7 | 0 | 0 | 0 | 29 | 29 | 98 | 96 | 93 |
| Example 8 | 0 | 0 | 59 | 0 | 0 | 94 | 93 | 93 |
| comparative | 0 | 60 | 0 | 0 | 0 | 88 | 87 | 85 |
| example 1 | | | | | | | | |
| comparative | 0 | 68 | 0 | 0 | 0 | 91 | 89 | 88 |
| example 2 | | | | | | | | |
| comparative | 38 | 0 | 0 | 0 | 0 | 86 | 86 | 84 |
| example 3 | | | | | | | | |
| comparative | 40 | 0 | 0 | 0 | 0 | 87 | 86 | 84 |
| example 4 | | | | | | | | |
| comparative | 58 | 0 | 0 | 0 | 0 | 88 | 86 | 83 |
| example 5 | | | | | | | | |
| comparative | 67 | 0 | 0 | 0 | 0 | 90 | 89 | 87 |
| example 6 | | | | | | | | |

What is claimed is:

1. An insulating white glass paste suitable for forming an insulating reflective layer to be provided on a lighting device substrate, comprising an organic medium and inorganic components comprising glass frit and zirconia powder as a light-reflecting filler.

2. The insulating white glass paste according to claim 1, wherein the zirconia powder is 5 to 80 volume % based on the total volume of the inorganic components.

3. The insulating white glass paste according to claim 1, wherein the specific surface area of the zirconia powder is 5 m²/g to 45 m²/g.

4. The insulating white glass paste according to claim 1, wherein the glass frit comprises at least BiO₂, B₂O₃ and SiO₂.

5. A lighting device substrate comprising an inorganic substrate and an insulating reflective layer containing glass and zirconia powder on one surface side of the inorganic substrate.

6. The lighting device substrate according to claim 5, further comprising a light-emitting device disposed on and/or next to said insulating reflective layer.

7. The lighting device substrate according to claim 5, further comprising a blue LED disposed on and/or next to said insulating reflective layer.

8. The lighting device substrate according to claim 5, further comprising a circuit on the substrate, wherein at least part of the insulating reflective layer is formed on top of at least part of the circuit.

9. The lighting device substrate according to claim 5, further comprising a circuit on the substrate, wherein said circuit is formed on top of a first insulating reflective layer formed on the substrate, and a second insulating reflective layer is formed on top of at least part of the circuit.

10. The lighting device substrate according to claim 5, wherein the substrate is a metal substrate or a ceramic substrate.

11. The lighting device substrate according to claim 5, wherein the zirconia powder is 5 to 80 volume % based on the total volume of the inorganic components.

12. The lighting device substrate according to claim 5, wherein the specific surface area of the zirconia powder is 5 m²/g to 40 m²/g.

13. The lighting device substrate according to claim 5, wherein the thickness of the insulating reflective layer is 10 μm to 30 μm.

14. A method of manufacturing a lighting device substrate, comprising steps of;
applying a glass paste comprising zirconia powder to one surface side of an inorganic substrate, and
firing the inorganic substrate and glass paste to thereby form an insulating reflective layer.

15. The method of forming a lighting device substrate according to claim 14, wherein the inorganic substrate is a metal substrate or a ceramic substrate.

16. The method of forming a lighting device substrate according to claim 14, wherein the content of said zirconia powder is 5 to 80 vol % based on the total volume of the inorganic components.

17. The method of forming a lighting device substrate according to claim 14, wherein the specific surface area of the zirconia powder is 5 m²/g to 40 m²/g.

18. The method of forming a lighting device substrate according to claim 14, wherein the thickness of the insulating reflective layer is 10 μm to 30 μm.

19. The method of forming a lighting device substrate according to claim 14, further comprising a step of disposing a light-emitting device on and/or next to the insulating reflective layer after the step of firing the inorganic substrate and glass paste.

20. The method of forming a lighting device substrate according to claim 14, wherein a blue LED is disposed on and/or next to the insulating reflective layer after the step of firing the inorganic substrate and glass paste.
